(19) United States
(12) Patent Application Publication
(10) Pub. No.: US 2025/0167620 A1
(43) Pub. Date: May 22, 2025

(54) ELECTRIC MOTOR CONFIGURATION

(71) Applicant: Joby Aero, Inc., Santa Cruz, CA (US)

(72) Inventors: Robert Ramm, Woodside, CA (US); Liam Chaffey, Monterey, CA (US)

(21) Appl. No.: 18/955,559

(22) Filed: Nov. 21, 2024

Related U.S. Application Data
(60) Provisional application No. 63/601,499, filed on Nov. 21, 2023.

(51) Int. Cl. H02K 3/50; H02K 1/16; H02K 1/278

(52) U.S. Cl. CPC H02K 3/50; H02K 1/16; H02K 1/278; H02K 2203/03

(57) ABSTRACT

An electric motor including a rotor and a stator. The rotor comprises a circumferential wall configured to receive and support an array of magnets, and a plurality of magnets arranged against the circumferential wall to form the array of magnets. An adhesive couples the plurality of magnets to the circumferential wall, the adhesive being in contact with the plurality of magnets and with one or more recesses formed in the circumferential wall. The stator comprises a plurality of teeth, and a wire coil wound around each one of the plurality of teeth, an end of the wire coil being stripped of insulation and wound around two spaced-apart posts formed on or adjacent to the teeth. The stripped wire makes contact with conductive tabs located on a stator holder.

### RELATED APPLICATION DATA

This application claims the benefit of U.S. Application Ser. No. 63/601,499 filed Nov. 21, 2023, the contents of which are incorporated herein by reference as if explicitly set forth.

### TECHNICAL FIELD

This invention relates generally to accessory motors for transportation, and more specifically in some examples to a new and useful motor to power a gerotor pump and fan combination for use in the aviation field.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a plan view of an aircraft according to some examples.

FIG. 2 is a schematic view of an aircraft energy system for use in the aircraft of FIG. 1, according to some examples.

FIG. 3A, FIG. 3B and FIG. 3C illustrate the tilting of an aircraft propulsion system and related components such as a propeller and nacelle according to some examples.

FIG. 4A, FIG. 4B and FIG. 4C illustrate the tilting of an aircraft propulsion system and related components such as a propeller and nacelle according to some examples.

FIG. 5 illustrates a partial cross section through the aircraft propulsion system of FIG. 3 and FIG. 4 according to some examples.

FIG. 6 is an exploded perspective view of a pump fan for use in the aircraft of FIG. 1, according to some examples.

FIG. 7 is a cross-section of the pump fan of FIG. 6, according to some examples.

FIG. 8 is a partial perspective cross-section of the rotor of the pump fan of FIG. 6, according to some examples.

FIG. 9 is a cross-section of the sidewall and magnet assembly of the rotor of FIG. 8, according to some examples.

FIG. 10 is a perspective view of a lamination stack for use in a tooth of the stator 702 of FIG. 8, according to some examples.

FIG. 11 is a cross section of the lamination stacks and coils of the wound duplet of FIG. 13, according to some examples.

FIG. 12 is a perspective view of an overmolded tooth including the lamination stack of FIG. 10, according to some examples.

FIG. 13 is a perspective view of a wound duplet including two of the teeth of FIG. 12, according to some examples.

FIG. 14 is a perspective view of a flexible printed circuit board assembly (PCBA), according to some examples.

FIG. 15 is a perspective view of a stator carrier, according to some examples.

FIG. 16 is a perspective view of an assembled stator, according to some examples.

FIG. 17 is a perspective view of an overmolded assembled stator 702, according to some examples.

FIG. 18 is a method of making a motor including a rotor 610 and stator 702, according to some examples.

### DETAILED DESCRIPTION

The rotor of an electric motor comprises a circumferential wall configured to receive and support an array of magnets, and a plurality of magnets arranged against the circumferential wall to form the array of magnets. An adhesive couples the plurality of magnets to the circumferential wall. The adhesive is in contact with the plurality of magnets and with one or more recesses formed in the circumferential wall. In some examples the adhesive flows into an undercut forming the recess, such that a mechanical joint is formed between the adhesive and the circumferential wall.

The stator of the electric motor comprises a plurality of teeth with a wire coil wound around each one of the plurality of teeth. An end of the wire coil is stripped of insulation and wound around two spaced-apart posts formed on or adjacent to the particular tooth. The stripped wire makes electrical contact with conductive tabs located on a stator holder, simplifying assembly.

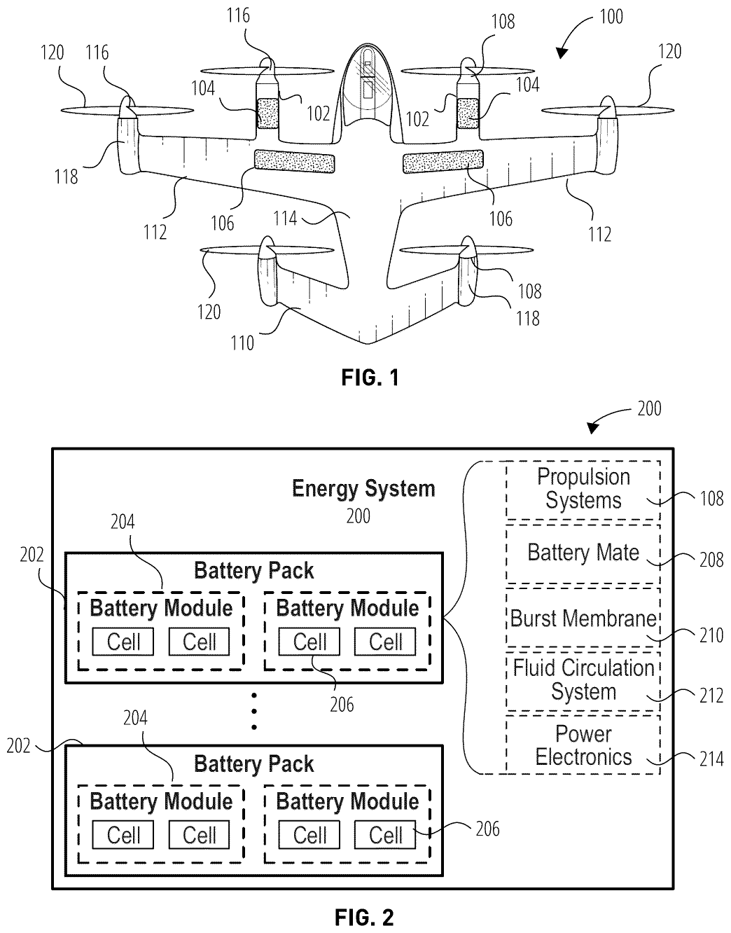

FIG. 1 is a plan view of an aircraft 100. The aircraft 100 includes a fuselage 114, two wings 112, an empennage 110, propulsion systems 108 embodied as tiltable rotor assemblies 116 located in nacelles 118, and rotors 120. The aircraft 100 includes one or more power sources embodied in FIG. 1 as nacelle battery packs 104 and wing battery packs 106. In the illustrated example, the nacelle battery packs 104 are located in inboard nacelles 102, but of course it will be appreciated that the nacelle battery packs 104 could be located in other nacelles 118 forming part of the aircraft 100. The battery packs form part of the energy system 200 described with reference to FIG. 2. The aircraft 100 will typically include associated equipment such as an electronic infrastructure, control surfaces, a cooling system, landing gear and so forth.

The wings 112 function to generate lift to support the aircraft 100 during forward flight. The wings 112 can additionally or alternately function to structurally support the battery packs 202, battery module 204 and/or propulsion systems 108 under the influence of various structural stresses (e.g., aerodynamic forces, gravitational forces, propulsive forces, external point loads, distributed loads, and/or body forces, etc.). The wings 112 can have any suitable geometry and/or arrangement on the aircraft.

FIG. 2 is a schematic view of an aircraft energy system 200 for use in the aircraft 100 of FIG. 1, according to some examples. As shown, the energy system 200 includes one or more battery packs 202. Each battery pack 202 may include one or more battery modules 204, which in turn may comprise a number of cells 206.

Typically associated with a battery pack 202 are one or more electric propulsion systems 108, a battery mate 208 for connecting it to other components in energy system 200, a burst membrane 210 as part of a venting system, a fluid circulation system 212 for cooling, and power electronics 214 for regulating delivery of electrical power (from the battery during operation and to the battery during charging) and to provide integration of the battery pack 202 with the electronic infrastructure of the energy system 200. As shown in FIG. 1, the propulsion systems 108 may comprise a plurality of rotor assemblies.

The electronic infrastructure and the power electronics 214 can additionally or alternately function to integrate the battery packs 202 into the energy system of the aircraft. The electronic infrastructure can include a Battery Management System (BMS), power electronics (HV architecture, power components, etc.), LV architecture (e.g., vehicle wire harness, data connections, etc.), and/or any other suitable components. The electronic infrastructure can include inter-module electrical connections, which can transmit power and/or data between battery packs and/or modules. Inter-modules can include bulkhead connections, bus bars, wire harnessing, and/or any other suitable components.

The battery packs 202 function to store electrochemical energy in a rechargeable manner for supply to the propulsion systems 108. Battery packs 202 can be arranged and/or distributed about the aircraft in any suitable manner. Battery packs can be arranged within wings (e.g., inside of an airfoil cavity), inside nacelles, and/or in any other suitable location on the aircraft. In a specific example, the system includes a first battery pack within an inboard portion of a left wing and a second battery pack within an inboard portion of a right wing. In a second specific example, the system includes a first battery pack within an inboard nacelle of a left wing and a second battery pack within an inboard nacelle of a right wing. Battery packs 202 may include a plurality of battery modules 204.

The energy system 200 includes a cooling system (e.g. fluid circulation system 212) that functions to circulate a working fluid within the battery pack 202 to remove heat generated by the battery pack 202 during operation or charging. Battery cells 206, battery module 204 and/or battery packs 202 can be fluidly connected by the cooling system in series and/or parallel in any suitable manner.

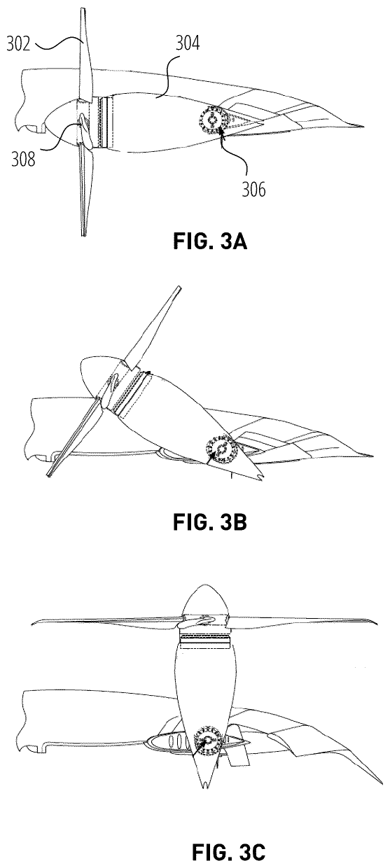

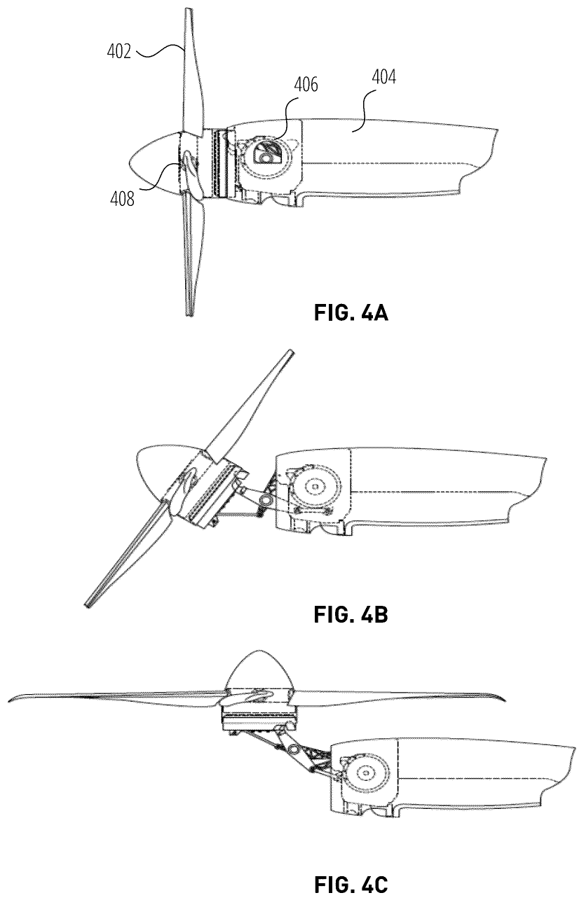

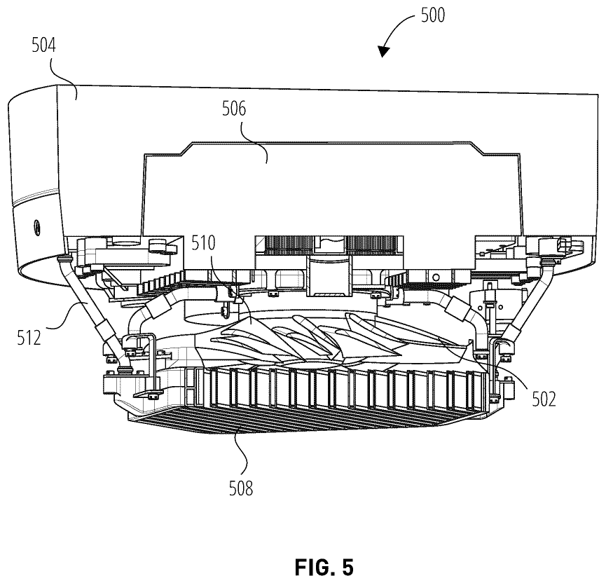

FIG. 3A, FIG. 3B and FIG. 3C illustrate the tilting of an aircraft propulsion system 500 (see FIG. 5) including related components such as a propeller 302 and a nacelle 304 according to some examples. The aircraft is preferably an eVTOL airplane (e.g., a multi-modal aircraft) as illustrated, but can additionally or alternatively include any suitable aircraft. The aircraft 100 is preferably a tiltrotor aircraft with a plurality of aircraft propulsion systems that are operable between a forward arrangement (FIG. 3A, and FIG. 4A) and a hover or vertical flight arrangement (FIG. 3C and FIG. 4C). However, the aircraft can alternatively be a fixed wing aircraft with one or more rotor assemblies or propulsion systems, a helicopter with one or more rotor assemblies (e.g., wherein at least one rotor assembly or aircraft propulsion system is oriented substantially axially to provide horizontal thrust), a tiltwing aircraft, a wingless aircraft (e.g., a helicopter, multi-copter, quadcopter), and/or any other suitable rotorcraft or vehicle propelled by propellers or rotors.

As shown in FIG. 3A to FIG. 3C, in one example a nacelle 304 including the aircraft propulsion system 500 and a propeller 302 with a blade-pitching mechanism 308 are tilted relative to the rest of the aircraft 100 by a tilt mechanism 306 located towards the rear of the nacelle 304.

When integrated into a propulsion tilt mechanism in an aircraft configurable between a forward configuration and a hover configuration, cooling subsystems can advantageously utilize an increase in available airflow in a hover configuration as discussed below.

FIG. 4A, FIG. 4B and FIG. 4C illustrate the tilting of the aircraft propulsion system 500 and related components such as the propeller 302 relative to a nacelle 404 according to some examples. As can be seen in FIG. 4B and FIG. 4C, in this example the aircraft propulsion system 500 and a propeller 402 with a blade-pitching mechanism 408 are tilted relative to the nacelle 404 by a tilt mechanism 406 located towards the front of the nacelle 404.

As can be seen in FIG. 4C, which is a hovering configuration, the radiator 508 is exposed to the open air as opposed to being contained within the nacelle 404 as in the vertical configuration. This results in more airflow through the radiator 508 both from the fan and as a result of adjacent airflow from the propeller 302. Since hovering has a higher power requirement than level flight, the additional cooling provided by the increased airflow through the radiator 508 can be advantageous.

FIG. 5 illustrates a partial cross section through an aircraft propulsion system 500. An inverter system 506 is nested within a radial interior of a motor 504. The aircraft propulsion system 500 also includes an integrated pump fan 502, a radiator 508 and conduits 512 forming a coolant path that passes through the motor 504, the inverter system 506 and the radiator 508. Also shown in FIG. 5 are cooling fins that provide additional cooling for the inverter system 506.

In use, the pump fan 502 circulates coolant through the radiator 508, the motor 504 and the inverter system 506, and also rotates the fan 510 to blow cooling air over the pump fan 502, the motor 504 and the inverter system 506.

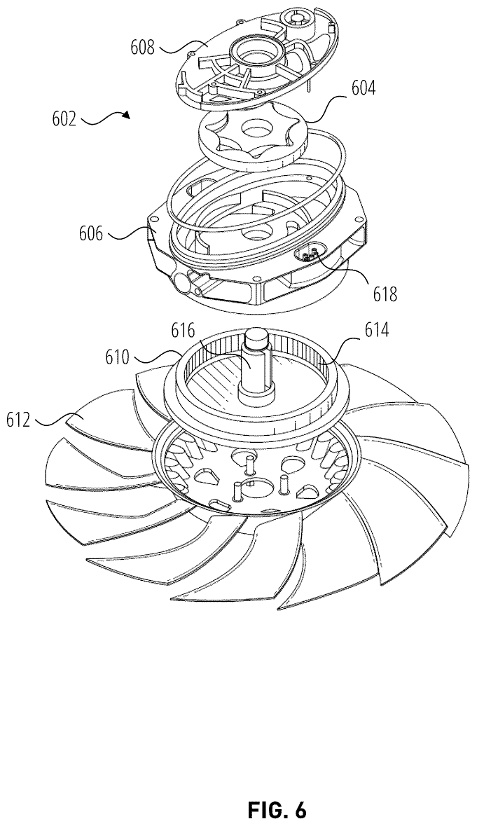

FIG. 6 is an exploded perspective view of a pump fan 600 having an electric motor therein including a rotor and a stator as described herein, according to some examples. The pump fan 600 includes a gerotor pump 602, a rotor 610 and a fan 612. The gerotor pump 602 comprises gerotors 604, a pump housing 606, and a cover 608.

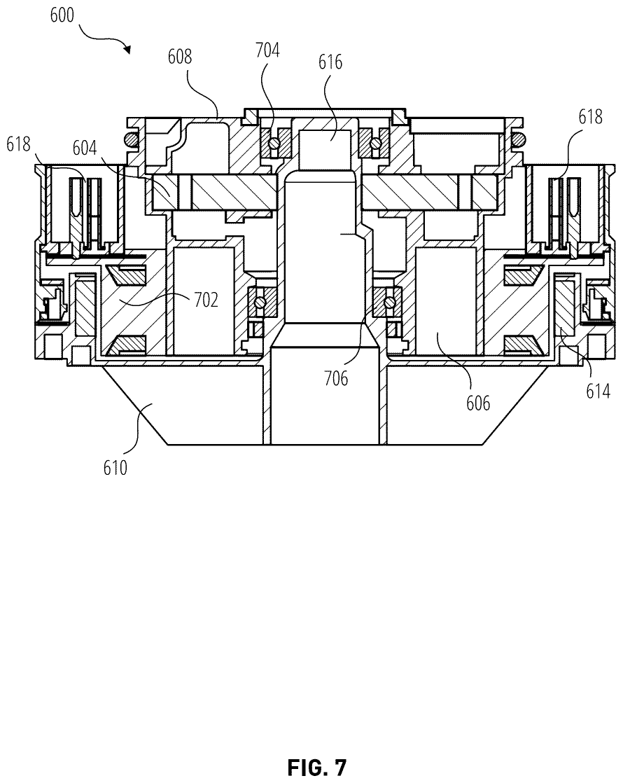

The rotor 610 includes a magnet assembly 614 and a shaft 616 by means of which the rotor 610 is coupled to the pump housing 606. The gerotors 604 are coupled to the shaft 616 of the rotor 610 and move relative to the pump housing 606 under the influence of magnetic fields created by a stator 702 (see FIG. 7), which forms part of the pump housing 606. The stator 702 is powered by electrical power received via the electrical connectors 618. As can be seen, the rotor 610 is configured as an outrunner rotor, and the electric motor formed by the stator 702 and the rotor 610 is thus an outrunner motor.

It will be appreciated that the features of the rotor 610 and stator 702 described herein are equally applicable to motors of other types and used in other uses.

FIG. 7 is a cross-section of the pump fan 600 of FIG. 6, according to some examples. Illustrated in the figure are the pump housing 606, the gerotors 604, the rotor 610 and the cover 608. Also visible is the magnet assembly 614 of the rotor 610, the electrical connectors 618 and stator 702 provided in the pump housing 606. The shaft 616 of the rotor 610 is held in place by the first bearing 704 and a second bearing 706.

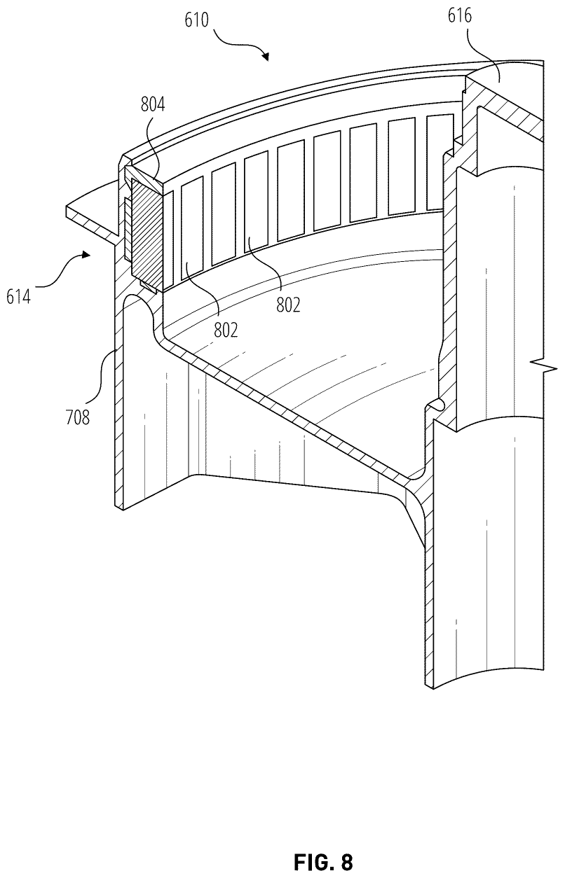

FIG. 8 is a partial perspective cross-section of the rotor 610 of the pump fan 600 of FIG. 6, according to some examples. Shown in FIG. 8 are the magnets 802 forming the magnet assembly 614, which are held in place by adhesive 804 that is molded around the sides, tops and bottoms of the magnets 802. The magnets 802 are held in place against the inner side of an outer circumferential wall 708 of the rotor 610 by the adhesive 804 as described in more detail below.

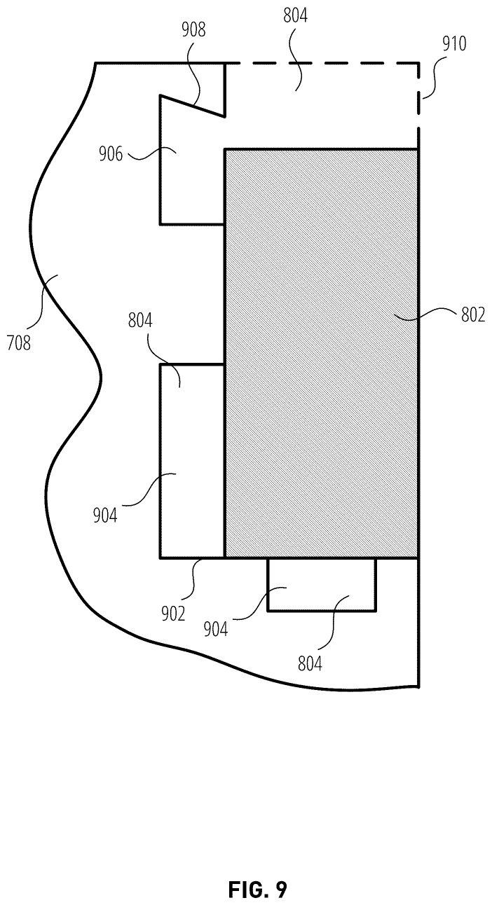

FIG. 9 is an axial cross-section of the circumferential wall 708 and magnet assembly 614 of the rotor 610 of FIG. 8, according to some examples. As can be seen, formed in the circumferential wall 708 is a ledge 902 onto which magnets 802 are placed to locate them in the correct position along the axis of rotation of the rotor 610. Also formed in the circumferential wall 708 are recesses 904, 906 that are filled with adhesive 804 to hold the magnets 802 in place.

Notably, recess 906 is partly defined by an undercut 908 that angles up and away from the magnet 802 similar to a half dovetail groove. When the adhesive 804 is molded around the magnet 802, it cures in place in the recess 906 and around the end of the magnet 802 as illustrated by the dashed line 910. The interaction between the cured adhesive 804 and the undercut 908 thus provides a mechanical joint that holds the adhesive 804 (and thus the magnet 802) in place against the circumferential wall 708.

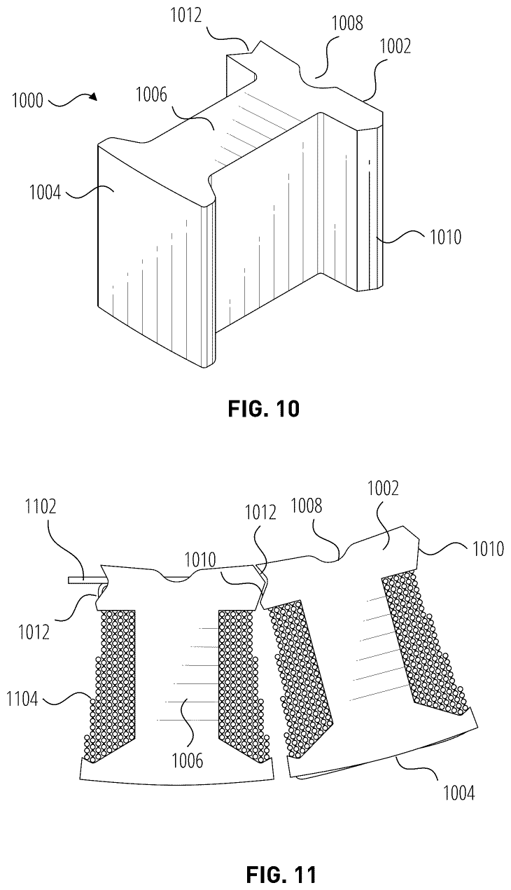

FIG. 10 is a perspective view of a lamination stack 1000 for use in a tooth of the stator 702 of FIG. 8, according to some examples, and FIG. 11 is a cross section of a wound duplet including two of the lamination stacks 1000 of FIG. 10, according to some examples. The lamination stack 1000 includes a central portion 1006, between a first end 1002 and a second end 1004, about which a wire 1102 can be wound to form a coil 1104. In an outrunner motor, the second end 1004 is located radially outward from the first end 1002, and the first ends 1002 of adjacent lamination stacks 1000 abut the ends of adjacent lamination stack 1000 as can be seen in FIG. 11.

The lamination stacks 1000 include a groove 1008 in the center of their second end 1004, also aligned in use with the axis of rotation of the rotor 610. Less flux passes through the lamination stack in this region, and providing the groove 1008 in the lamination stacks 1000 reduces the mass of the stator 702 with a minimal performance effect.

One side of the first end 1002 is provided with a raised edge 1010, while the other side has a corresponding matched groove 1012 into which the raised edge 1010 of an adjacent lamination stack 1000 fits. The matching raised edge 1010 and groove 1012 provide an increased area through which flux can pass between the two adjacent amination stacks in use, improving performance of the stator. While the illustrated raised edge 1010 and groove 1012 are peaked or triangular in some examples, it will be appreciated that other matching shapes could be used to increase the contact area between two adjacent first ends 1002 over the contact area that would occur between two flat edges perpendicular to the first ends 1002.

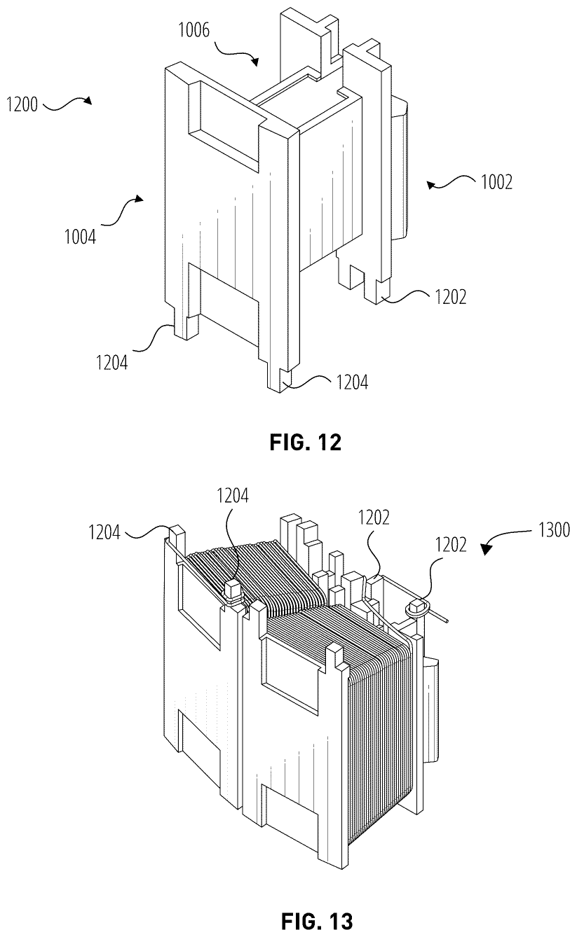

FIG. 12 is a perspective view of an overmolded tooth 1200 including the lamination stack 1000 of FIG. 10, according to some examples. The overmolded tooth 1200 is formed by overmolding plastic over the lamination stack 1000. The plastic overmold provides various features to facilitate the winding of the coils 1104 and the subsequent assembly of the overmolded tooth 1200 into the completed stator 702.

In particular the overmolded tooth 1200 includes two spaced apart posts 1202 at the first end 1002, and two spaced apart posts 1204 at the second end 1004. The winding of the coils 1104 is an automated process, and the coils of two teeth in a duplet are wound, one after the other, by a coil winding machine as described below with reference to FIG. 8.

FIG. 13 is a perspective view of a wound duplet 1300 including two of the overmolded teeth 1200 of FIG. 6, according to some examples. The view of the overmolded teeth 1200 in FIG. 13 is inverted from the view of the overmolded tooth 1200 in FIG. 12.

The coil winding machine performs the following operations. Before the wire 1102 forming the coil 1104 is wound into the central portion 1006, the coil winding machine strips a starting end of the wire 1102 of its insulation and then wraps the exposed end of the wire around the two posts 1202 (or the posts 1204 as the case may be) of the first overmolded tooth 1200 in the duplet. The wire is then would around the central portion 1006 of the overmolded tooth 1200 to form a coil 1104 for that tooth. The winding machine then moves across to the second overmolded tooth 1200 and winds the wire 1102 around the central portion 1006 of that tooth, to form a coil around the second tooth. The coil winding machine strips the terminating end of the wire 1102 of its insulation and wraps the exposed terminating end of the wire around the two posts 1204 (or posts 1202 as the case may be) of the second overmolded tooth 1200 in the duplet 1300.

This process is repeated for all of the duplets 1300 that will form the stator 702.

Wrapping exposed ends of the wire 1102 around the posts 1202, posts 1204 provides a known location for making electrical connection with each duplet 1300.

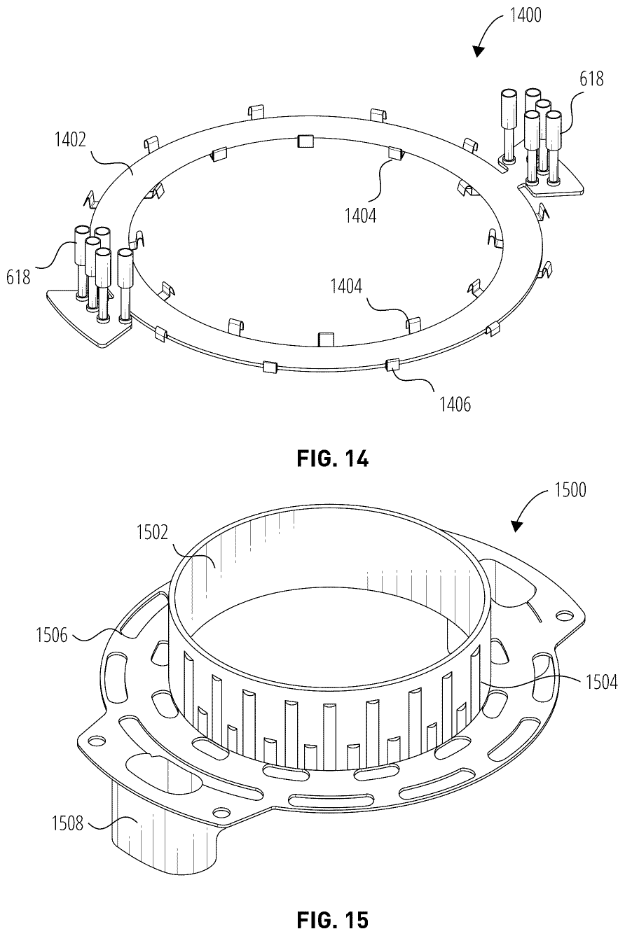

FIG. 14 is a perspective view of a flexible printed circuit board assembly, PCBA 1400, according to some examples. The PCBA 1400 includes a PCB 1402 provided as a flat ring, the electrical connectors 618, and a number of conductive inner tabs 1404 located on an inner circumference of the PCB 1402 and outer tabs 1406 located on an outer circumference of the PCB 1402. An offset pair of tabs comprising an inner tab 1404 and an outer tab 1406 are provided for each wound duplet 1300 described above. The tabs 1404, 1406 are arranged so that an inner tab 1404 will make contact with the stripped end of wire 1102 wrapped around the posts 1202, while an outer tab 1406 will make contact with the stripped end of wire 1102 wrapped around the posts 1204 when each wound duplet 1300 is placed correctly on the PCB 1402.

Appropriate electrical conductors are provided between the inner tabs 1404, outer tabs 1406 and electrical connectors 618 so that it is not necessary for any additional manual or automated labor to be performed, such as spot-welding the stripped ends of the wires 1102 to terminals on the PCB 1402 as would be done conventionally, to provide reliable electrical connection with the coils 1104 in the overmolded teeth 1200.

FIG. 15 is a perspective view of a stator carrier 1500, according to some examples. The stator carrier 1500 includes a flange 1506 for receiving and supporting the PCBA 1400, as well as cylindrical tube 1502 for supporting the wound duplets 1300 and for supporting and aligning the duplets 1300 with each other and with the PCBA 1400. The tube 1502 includes axially-aligned ridges forming alignment features 1504, to assist with the correct placement and alignment of the duplets 1300 on the stator carrier 1500. The stator carrier 1500 also includes a connector housing 1508, which receives and retains the electrical connectors 618 and facilitates the connection of an electrical cable to the assembled stator 702.

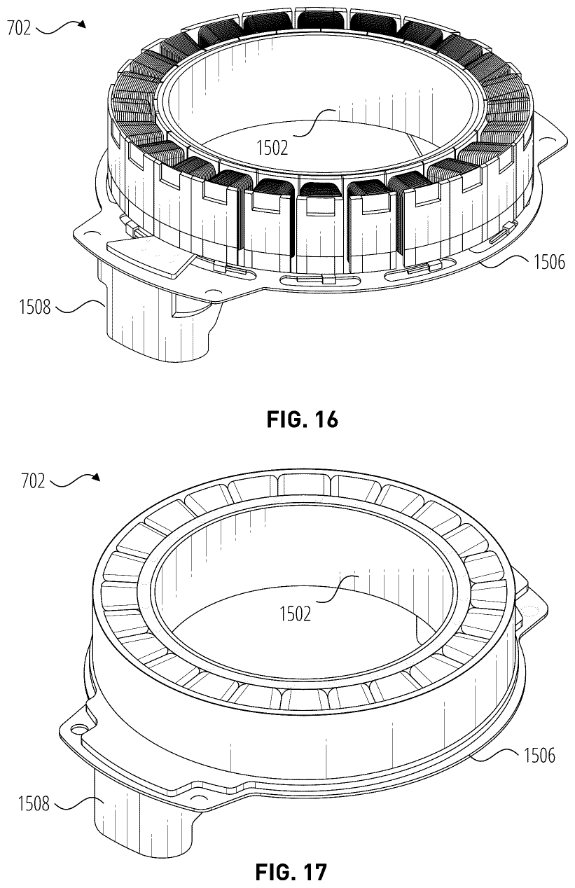

FIG. 16 is a perspective view of an assembled stator 702, according to some examples. The stator 702 is assembled by placing the PCBA 1400 onto the flange 1506 of the stator carrier 1500 and then placing the wound duplets 1300 in place on the PCBA 1400. The duplets 1300 are positioned so that the stripped ends of the wire 1102, wrapped around the posts 1202 and posts 1204 as discussed above, make electrical contact with the inner tabs 1404 and outer tabs 1406, respectively.

FIG. 17 is a perspective view of an overmolded assembled stator 702, according to some examples. The assembled stator 702 of FIG. 16 is provided with a sealing plastic overmold that encases the duplets 1300, PCBA 1400, stator carrier 1500 and the connector housing 1508. This provides additional durability to the stator 702 and prevents contaminants from reaching the coils 1104 or other parts of the stator 702.

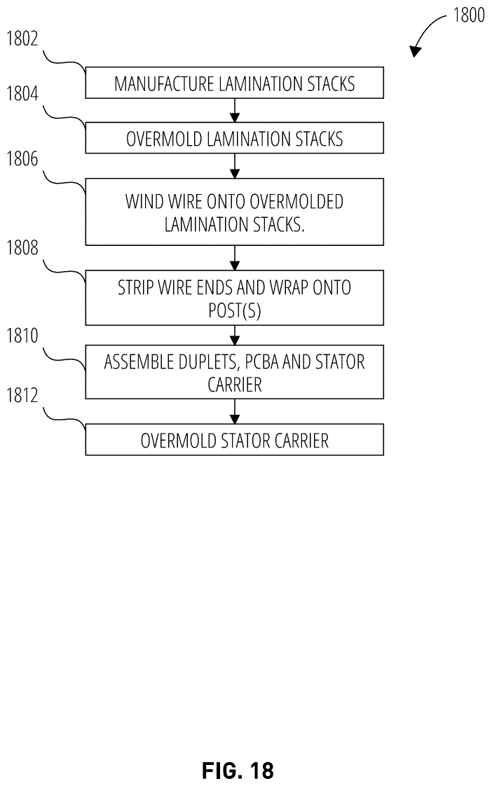

FIG. 18 is a flowchart 1800 illustrating a method of making a motor including a rotor 610 and stator 702, according to some examples. The method commences at operation 1802 with making of the lamination stack 1000 including a central portion 1006 between a first end 1002 and a second end 1004, and having a groove 1008 in the center of the second end 1004. One side of the first end 1002 is provided with a raised edge 1010, while the other side has a corresponding matched groove 1012 into which the raised edge 1010 of an adjacent lamination stack 1000 fits. The lamination stack 1000 is made using known techniques, including in some examples, stamping, insulation coating, stacking, and bonding.

In operation 1804, the lamination stack 1000 is overmolded to form the overmolded tooth 1200 described above with reference to FIG. 12, with two spaced apart posts 1202 at the first end 1002 of the lamination stack 1000, and two spaced apart posts 1204 at the second end 1004 of the lamination stack. Alternatively, two versions of the overmolded tooth 1200 can be made, in which the spaced apart posts 1202 are found on one version while the offset spaced apart posts 1204 are found on the second version. The two versions can then be alternated in the stator, to provide the wound configuration shown in FIG. 13.

The wire 1102 is then wound around the overmolded central portions of two overmolded teeth 1200 to form a duplet 1300 in operation 1806. Each end of the wire 1102 is stripped and one stripped end is wound around the two posts 1202 while the other stripped end is wound around the two posts 1202 in operation 1808. This occurs separately at the beginning and end of the winding process in some examples.

The PCBA 1400 and wound duplets 1300 are then assembled onto the stator carrier 1500 in operation 1810, with the stripped ends of the wires 1102 around the posts 1202 in contact with the inner tabs 1404 of the PCBA 1400 and the stripped ends of the wires 1102 around the posts 1204 in contact with the outer tab 1406.

The assembled stator 702 is then overmolded in operation 1812.

Various examples are contemplated. Example 1 is an electric motor including a rotor and a stator, the rotor comprising: a circumferential wall configured to receive and support an array of magnets; a plurality of magnets arranged against the circumferential wall to form the array of magnets; and an adhesive coupling the plurality of magnets to the circumferential wall, the adhesive being in contact with the plurality of magnets and with one or more recesses formed in the circumferential wall.

In Example 2, the subject matter of Example 1 includes, wherein a recess of the one or more recesses is formed with an undercut such that a mechanical joint is formed between the undercut and adjacent adhesive.

In Example 3, the subject matter of Examples 1-2 includes, wherein the rotor further comprises a ledge adjacent to the circumferential wall for receiving and supporting the array of magnets, the ledge having a recess formed therein for receiving the adhesive.

In Example 4, the subject matter of Examples 2-3 includes, wherein the rotor further comprises a ledge adjacent to the circumferential wall for receiving and supporting the array of magnets, the ledge having a recess formed therein for receiving the adhesive.

In Example 5, the subject matter of Examples 1-4 includes, wherein the stator comprises: a plurality of teeth; and a wire coil wound around each one of the plurality of teeth, an end of the wire coil being stripped of insulation and wound around two spaced-apart posts formed on or adjacent to each one of the plurality of teeth.

In Example 6, the subject matter of Example 5 includes, a circuit board for receiving the plurality of teeth, the circuit board including a plurality of spaced-apart conductive tabs positioned to make contact with the stripped ends of the wire coils of the plurality of teeth, the circuit board further comprising electrical conductors between the conductive tabs and a plurality of terminals in an electrical connector.

In Example 7, the subject matter of Example 6 includes, wherein the circuit board is formed as a flat ring with an inner circumference and an outer circumference, and the conductive tabs are arranged at intervals along the inner circumference and the outer circumference.

In Example 8, the subject matter of Example 7 includes, wherein the plurality of teeth are arranged in pairs comprising a first tooth and a second tooth, the first tooth having a first stripped end of a wire coil wrapped around a first set of posts, and the second tooth having a second stripped end of the wire coil wrapped around a second set of posts.

In Example 9, the subject matter of Example 8 includes, wherein the first set of posts is positioned such that the first stripped end of the wire coil wrapped around the first set of posts makes contact with a conductive tab located along the inner circumference of the circuit board and the second set of posts is positioned such that the second stripped end of the wire coil wrapped around the second set of posts makes contact with a conductive tab located along the outer circumference of the circuit board.

Example 10 is an electric motor including a rotor and a stator, the stator comprising: a plurality of teeth; and a wire coil wound around each one of the plurality of teeth, an end of the wire coil being stripped of insulation and wound around two spaced-apart posts formed on or adjacent to each one of the plurality of teeth.

In Example 11, the subject matter of Example 10 includes, a circuit board for receiving the plurality of teeth, the circuit board including a plurality of spaced-apart conductive tabs positioned to make contact with the stripped ends of the wire coils of the plurality of teeth, the circuit board further comprising electrical conductors between the conductive tabs and a plurality of terminals in an electrical connector.

In Example 12, the subject matter of Example 11 includes, wherein the circuit board is formed as a flat ring with an inner circumference and an outer circumference, and the conductive tabs are arranged at intervals along the inner circumference and the outer circumference.

In Example 13, the subject matter of Example 12 includes, wherein the plurality of teeth are arranged in pairs comprising a first tooth and a second tooth, the first tooth having a first stripped end of a wire coil wrapped around a first set of posts, and the second tooth having a second stripped end of the wire coil wrapped around a second set of posts.

In Example 14, the subject matter of Example 13 includes, wherein the first set of posts is positioned such that the stripped end of the wire coil wrapped around the first set of posts makes contact with a conductive tab located along the inner circumference of the circuit board and the second set of posts is positioned such that the stripped end of the wire coil wrapped around the second set of posts makes contact with a conductive tab located along the outer circumference of the circuit board.

In Example 15, the subject matter of Examples 10-14 includes, wherein the plurality of teeth are arranged in pairs comprising a first tooth and a second tooth, the first tooth having a first stripped end of a wire coil wrapped around a first set of posts, and the second tooth having a second stripped end of the wire coil wrapped around a second set of posts.

In Example 16, the subject matter of Example 15 includes, wherein the first set of posts is located radially inward of the second set of posts.

In Example 17, the subject matter of Examples 15-16 includes, a rotor including an inner circumferential wall; and a plurality of magnets arranged against the inner circumferential wall of the rotor, wherein the plurality of magnets are coupled to the inner circumferential wall by an adhesive that is in contact with the plurality of magnets and with one or more recesses formed in the inner circumferential wall.

In Example 18, the subject matter of Example 17 includes, wherein a recess of the one or more recesses is formed with an undercut such that a mechanical joint is formed between the undercut and adjacent adhesive.

In Example 19, the subject matter of Examples 17-18 includes, wherein the rotor further comprises a ledge adjacent to the inner circumferential wall for receiving and supporting the plurality of magnets, the ledge having a recess formed therein for receiving the adhesive.

In Example 20, the subject matter of Examples 18-19 includes, wherein the rotor further comprises a ledge adjacent to the inner circumferential wall for receiving and supporting the plurality of magnets, the ledge having a recess formed therein for receiving the adhesive.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20. Example 23 is a system to implement of any of Examples 1-20. Example 24 is a method to implement of any of Examples 1-20.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

The term “rotor” as utilized herein when referring to a thrust-generating element, can refer to a rotor, a propeller, and/or any other suitable rotary aerodynamic actuator. While a rotor can refer to a rotary aerodynamic actuator that makes use of an articulated or semi-rigid hub (e.g., wherein the connection of the blades to the hub can be articulated, flexible, rigid, and/or otherwise connected), and a propeller can refer to a rotary aerodynamic actuator that makes use of a rigid hub (e.g., wherein the connection of the blades to the hub can be articulated, flexible, rigid, and/or otherwise connected), no such distinction is explicit or implied when used herein, and the usage of “rotor” can refer to either configuration, and any other suitable configuration of articulated or rigid blades, and/or any other suitable configuration of blade connections to a central member or hub. Likewise, the usage of “propeller” can refer to either configuration, and any other suitable configuration of articulated or rigid blades, and/or any other suitable configuration of blade connections to a central member or hub. Accordingly, the tiltrotor aircraft can be referred to as a tilt-propeller aircraft, a tilt-prop aircraft, and/or otherwise suitably referred to or described.

The term “board” as utilized herein, in reference to the control board, inverter board, or otherwise, preferably refers to a circuit board. More preferably, “board” refers to a printed circuit board (PCB) and/or electronic components assembled thereon, which can collectively form a printed circuit board assembly (PCBA). In a first example, the control board is a PCBA. In a second example, each inverter board is a PCBA. However, “board” can additionally or alternatively refer to a single sided PCB, double sided PCB, multi-layer PCB, rigid PCB, flexible PCB, and/or can have any other suitable meaning.

The aircraft can include any suitable form of power storage or power storage unit (battery, flywheel, ultra-capacitor, hydrogen fuel cell, fuel tank, etc.) that powers the actuator(s) (e.g., rotor/propeller, tilt mechanism, blade pitch mechanism, cooling systems, etc.). The preferred power/fuel source is a battery, however the system could reasonably be employed with any suitable power/fuel source. The aircraft can include auxiliary and/or redundant power sources (e.g., backup batteries, multiple batteries) or exclude redundant power sources. The aircraft can employ batteries with any suitable cell chemistries (e.g., Li-ion, nickel cadmium, etc.) in any suitable electrical architecture or configuration (e.g., multiple packs, bricks, modules, cells, etc.; in any combination of series and/or parallel architecture).

In a specific example, the system integrated into an electric tiltrotor aircraft including a plurality of tiltable rotor assemblies (e.g., six tiltable rotor assemblies). The electric tiltrotor aircraft can operate as a fixed wing aircraft, a rotary-wing aircraft, and in any liminal configuration between a fixed and rotary wing state (e.g., wherein one or more of the plurality of tiltable rotor assemblies is oriented in a partially rotated state). The control system of the electric tiltrotor aircraft in this example can function to command and control the plurality of tiltable rotor assemblies within and/or between the fixed wing arrangement and the rotary-wing arrangement.

The term “substantially” as utilized herein can mean: exactly, approximately, within a predetermined threshold or tolerance, and/or have any other suitable meaning.

Alternative embodiments implement the above methods and/or processing modules m non-transitory computer-readable media, storing computer-readable instructions. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the examples of the invention without departing from the scope of this invention defined in the following claims.

What is claimed is:

1. An electric motor including a rotor and a stator, the rotor comprising:
a circumferential wall configured to receive and support an array of magnets;
a plurality of magnets arranged against the circumferential wall to form the array of magnets; and
an adhesive coupling the plurality of magnets to the circumferential wall, the adhesive being in contact with the plurality of magnets and with one or more recesses formed in the circumferential wall.

2. The electric motor of claim 1, wherein a recess of the one or more recesses is formed with an undercut such that a mechanical joint is formed between the undercut and adjacent adhesive.

3. The electric motor of claim 1, wherein the rotor further comprises a ledge adjacent to the circumferential wall for receiving and supporting the array of magnets, the ledge having a recess formed therein for receiving the adhesive.

4. The electric motor of claim 2, wherein the rotor further comprises a ledge adjacent to the circumferential wall for receiving and supporting the array of magnets, the ledge having a recess formed therein for receiving the adhesive.

5. The electric motor of claim 1, wherein the stator comprises:
a plurality of teeth; and
a wire coil wound around each one of the plurality of teeth, an end of the wire coil being stripped of insulation and wound around two spaced-apart posts formed on or adjacent to each one of the plurality of teeth.

6. The electric motor of claim 5, further comprising:
a circuit board for receiving the plurality of teeth, the circuit board including a plurality of spaced-apart conductive tabs positioned to make contact with the stripped ends of the wire coils of the plurality of teeth, the circuit board further comprising electrical conductors between the conductive tabs and a plurality of terminals in an electrical connector.

7. The electric motor of claim 6, wherein the circuit board is formed as a flat ring with an inner circumference and an outer circumference, and the conductive tabs are arranged at intervals along the inner circumference and the outer circumference.

8. The electric motor of claim 7, wherein the plurality of teeth are arranged in pairs comprising a first tooth and a second tooth, the first tooth having a first stripped end of a wire coil wrapped around a first set of posts, and the second tooth having a second stripped end of the wire coil wrapped around a second set of posts.

9. The electric motor of claim 8, wherein the first set of posts is positioned such that the first stripped end of the wire coil wrapped around the first set of posts makes contact with a conductive tab located along the inner circumference of the circuit board and the second set of posts is positioned such that the second stripped end of the wire coil wrapped around the second set of posts makes contact with a conductive tab located along the outer circumference of the circuit board.

10. An electric motor including a rotor and a stator, the stator comprising:
a plurality of teeth; and
a wire coil wound around each one of the plurality of teeth, an end of the wire coil being stripped of insulation and wound around two spaced-apart posts formed on or adjacent to each one of the plurality of teeth.

11. The electric motor of claim 10, further comprising:
a circuit board for receiving the plurality of teeth, the circuit board including a plurality of spaced-apart conductive tabs positioned to make contact with the stripped ends of the wire coils of the plurality of teeth, the circuit board further comprising electrical conductors between the conductive tabs and a plurality of terminals in an electrical connector.

12. The electric motor of claim 11, wherein the circuit board is formed as a flat ring with an inner circumference and an outer circumference, and the conductive tabs are arranged at intervals along the inner circumference and the outer circumference.

13. The electric motor of claim 12, wherein the plurality of teeth are arranged in pairs comprising a first tooth and a second tooth, the first tooth having a first stripped end of a wire coil wrapped around a first set of posts, and the second tooth having a second stripped end of the wire coil wrapped around a second set of posts.

14. The electric motor of claim 13, wherein the first set of posts is positioned such that the stripped end of the wire coil wrapped around the first set of posts makes contact with a conductive tab located along the inner circumference of the circuit board and the second set of posts is positioned such that the stripped end of the wire coil wrapped around the second set of posts makes contact with a conductive tab located along the outer circumference of the circuit board.

15. The electric motor of claim 10, wherein the plurality of teeth are arranged in pairs comprising a first tooth and a second tooth, the first tooth having a first stripped end of a wire coil wrapped around a first set of posts, and the second tooth having a second stripped end of the wire coil wrapped around a second set of posts.

16. The electric motor of claim 15, wherein the first set of posts is located radially inward of the second set of posts.

17. The electric motor of claim 15, further comprising:
a rotor including an inner circumferential wall; and
a plurality of magnets arranged against the inner circumferential wall of the rotor, wherein the plurality of magnets are coupled to the inner circumferential wall by an adhesive that is in contact with the plurality of magnets and with one or more recesses formed in the inner circumferential wall.

18. The electric motor of claim 17, wherein a recess of the one or more recesses is formed with an undercut such that a mechanical joint is formed between the undercut and adjacent adhesive.

19. The electric motor of claim 17, wherein the rotor further comprises a ledge adjacent to the inner circumferential wall for receiving and supporting the plurality of magnets, the ledge having a recess formed therein for receiving the adhesive.

20. The electric motor of claim 18, wherein the rotor further comprises a ledge adjacent to the inner circumferential wall for receiving and supporting the plurality of magnets, the ledge having a recess formed therein for receiving the adhesive.
